(19) United States
(12) Patent Application Publication
(10) Pub. No.: US 2026/0037590 A1
(43) Pub. Date: Feb. 5, 2026

(54) METHOD FOR RENDERING WEBPAGE, SERVER AND STORAGE MEDIUM

(71) Applicant: Shopline Commerce Pte. Ltd., Singapore (SG)

(72) Inventor: Zhimeng Wang, Guangzhou (CN)

(21) Appl. No.: 19/357,373

(22) Filed: Oct. 14, 2025

(30) Foreign Application Priority Data
Mar. 10, 2025 (CN) 202510280408.7

(51) Int. Cl. G06F 16/958; G06F 8/41

(52) U.S. Cl. CPC G06F 16/958; G06F 8/427

(57) ABSTRACT

A method for rendering a webpage. The method includes obtaining a template file according to a page identifier of a page to be accessed of page access request by invoking a template engine developed based on a compiled language; generating an abstract syntax tree by parsing the template file through the template engine, and performing a static verification and an optimization on the logical relationship information of the template file by the template engine based on the abstract syntax tree, and obtaining optimized rendering codes by binding business data obtained from a data source to variable in the template file according to the correspondence relationship between the variable and the business data; and generating final page codes based on the optimized rendering codes through the template engine and removing redundant information from the final page codes and sending the final page codes to the client device for rendering and displaying.

### FIELD

The object to be tested matter herein generally relates to webpage generation technology, and in particular to a method for rendering a webpage, a sever and a storage medium.

### BACKGROUND

In an e-commerce platform, fast response and efficient rendering of webpages are crucial for enhancing user experience and promoting transactions. However, existing webpage rendering technologies face following technical problems when dealing with high concurrent access and complex business logic in e-commerce platforms:

First, existing rendering technologies often rely on template engines developed using interpreted languages, which are inefficient when processing complex template files. Especially in high-concurrency scenarios of the e-commerce platform, the template engine needs to frequently parse template files and bind business data, leading to slow page rendering speed, increased user waiting time, and reduced user experience.

Second, existing template engines lack effective static verification mechanism for template logic when processing template files. This means that logical relationships such as variable scope, expression priority, predefined tags, etc., may only be checked when the template engine is running, and cannot be thoroughly inspected during the rendering stage. Once errors occur, it often leads to page rendering failure or incorrect content display. In e-commerce platform, such errors not only affect user experience but may also lead to incorrect display of transaction information, or even cause security issues.

Furthermore, existing rendering technologies lack optimization processing for the generated HTML codes when generating final page codes. The HTML codes often includes a large amount of redundant information, such as excessive whitespace characters and comments, which not only increases a amount of data transmitted for the page but also reduces the page loading speed. In the e-commerce platform, delays in page loading speed may lead to user churn, thereby affecting the commercial benefits of the platform.

Thus, existing webpage rendering technologies face problems such as low rendering efficiency, lack of static verification mechanisms, and unoptimized HTML codes when dealing with high concurrent access and complex business logic in the e-commerce platform. These problems limit user experience and commercial benefits of the e-commerce platform, urgently requiring a new solution to overcome these technical bottlenecks.

### BRIEF DESCRIPTION OF THE DRAWINGS

FIG. 1 is an exemplary network architecture provided by an embodiment of the present disclosure, where a server may be used to execute a computer program product implementing the method for rendering a webpage according to the present disclosure.

FIG. 2 is a schematic flowchart of an embodiment of the method for rendering the webpage provided by an embodiment of the present disclosure.

FIG. 3 is a schematic flowchart of an embodiment of the method for performing a static verification and optimization on the logical relationship information in the template file provided by an embodiment of the present disclosure.

FIG. 4 is a schematic flowchart of an embodiment of the method for binding the business data obtained from the data source to the corresponding variables in the template file provided by an embodiment of the present disclosure.

FIG. 5 is a schematic flowchart of an embodiment of the method for generating the final page codes from the rendering code and removing redundant information, and sending the final page codes to the client device for rendering and displaying provided by an embodiment of the present disclosure.

FIG. 6 is a schematic flowchart of an embodiment of the method for generating the final page codes from the rendering code and removing redundant information, and sending the final page codes to the client device for rendering and displaying provided by an embodiment of the present disclosure.

FIG. 7 is a schematic flowchart of an embodiment of the method for binding the business data obtained from the data source to the corresponding variables in the template file provided by an embodiment of the present disclosure.

FIG. 8 is a schematic flowchart of another embodiment of the method for rendering the webpage provided by an embodiment of the present disclosure.

FIG. 9 is a block diagram of an apparatus for rendering webpage provided by an embodiment of the present disclosure.

FIG. 10 is a schematic structural diagram of a server provided by an embodiment of the present disclosure.

### DETAILED DESCRIPTION

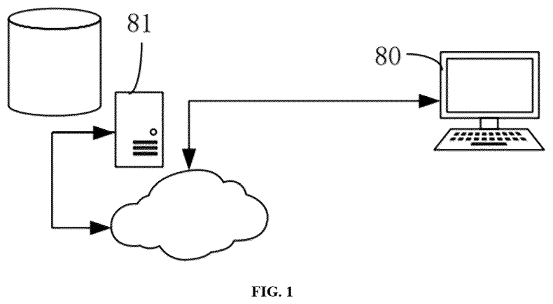

As shown in FIG. 1, the network architecture of the present disclosure mainly includes a server 81 and a terminal device 80 acting as a client device. In an exemplary application scenario of the present disclosure, the server 81, as a core server cluster of the e-commerce platform, runs a computer program product implementing the method for rendering a webpage according to the present disclosure. By running the corresponding computer program, it undertakes function of responding to requests from the client device 80, invoking a template engine to render a template file, obtaining final page codes of the requested page, and returning the final page codes to the client device.

The template engine of the present disclosure is suitable for rendering various pages, including but not limited to a website page, an email layout page, a page embedded within applications on the terminal device, etc. The common feature of such pages is that they all have a final page codes form described in HTML.

For example, in actual operation of an e-commerce platform, especially in high-concurrency scenarios such as product rush purchases, quickly responding to client device requests and efficiently rendering the webpage is crucial. For instance, in an exemplary product rush purchase scenario, a user sends a page access request to the front-end server through a terminal device (such as a computer, mobile phone, etc.). After receiving the request, the front-end server, according to the page identifier contained in the request, invokes the template engine to obtain the corresponding template file. The template engine parses the template file, generates an abstract syntax tree, which may clearly represent the logical relationship information among mixed operation expressions, variable scopes, predefined tags, business data filters, and control statements within the template file. Based on this, the template engine may perform the static verification and optimization on the logical relationships in the template file, bind business data obtained from a data source to the corresponding variables in the template file, ultimately generate optimized rendering codes, and then generate the final page codes for the website page to return to the client device for rendering and displaying.

In the present disclosure, the template engine is a key component for implementing the above process. It is developed based on a compiled language and compared to traditional interpreted template engines, it has higher execution efficiency and stronger business processing capabilities. In the present disclosure, the template engine may not only quickly parse template files but also construct an abstract syntax tree during the parsing phase, achieving the static verification and optimization of template logic, discovering and correcting potential errors in advance, ensuring the accuracy and stability of page rendering. Furthermore, when generating the final page codes, the template engine may perform redundant information cleanup, removing excess whitespace characters and comments, making the generated HTML codes more concise and efficient, reducing the amount of data transmitted for the page, speeding up page loading, thereby enhancing user experience.

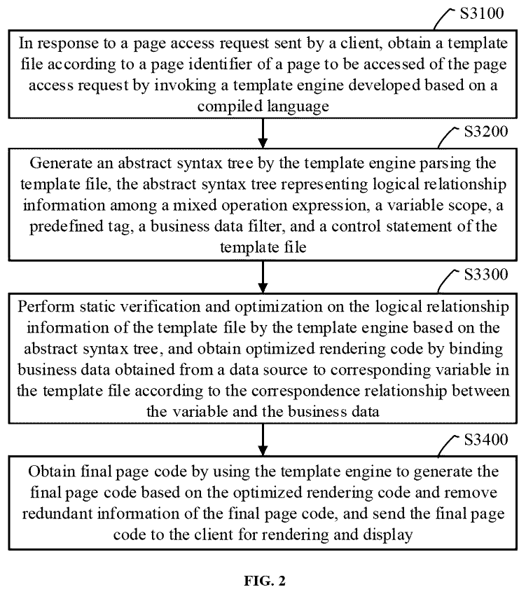

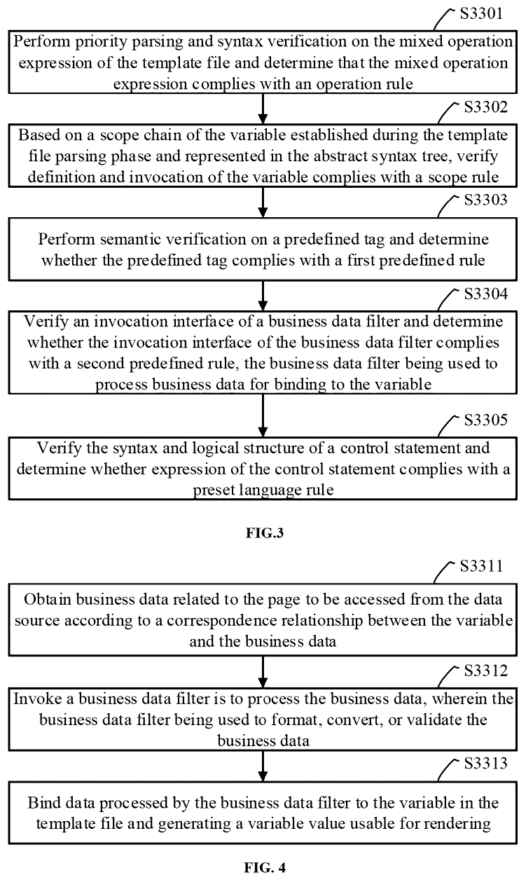

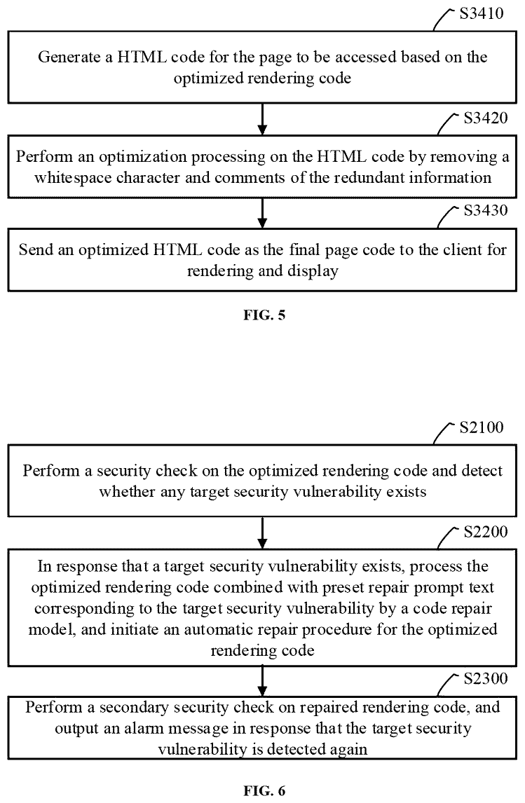

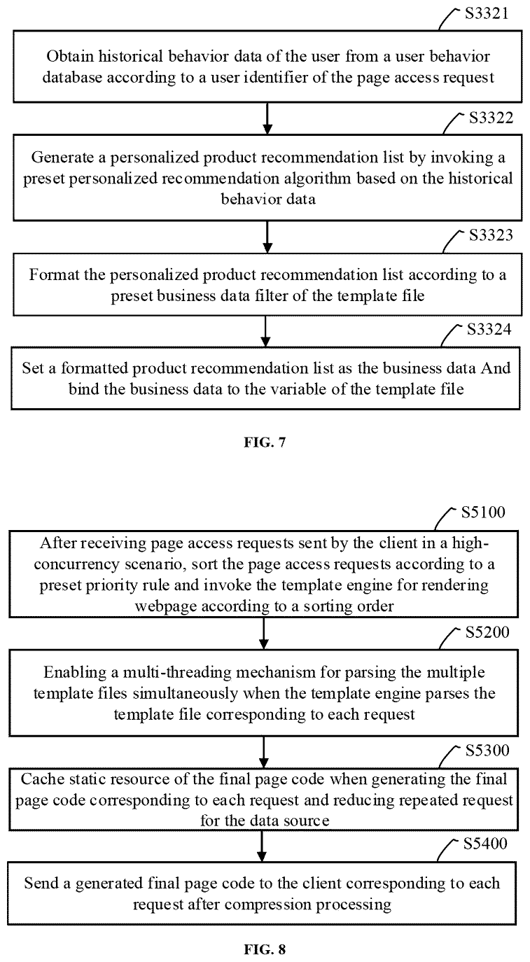

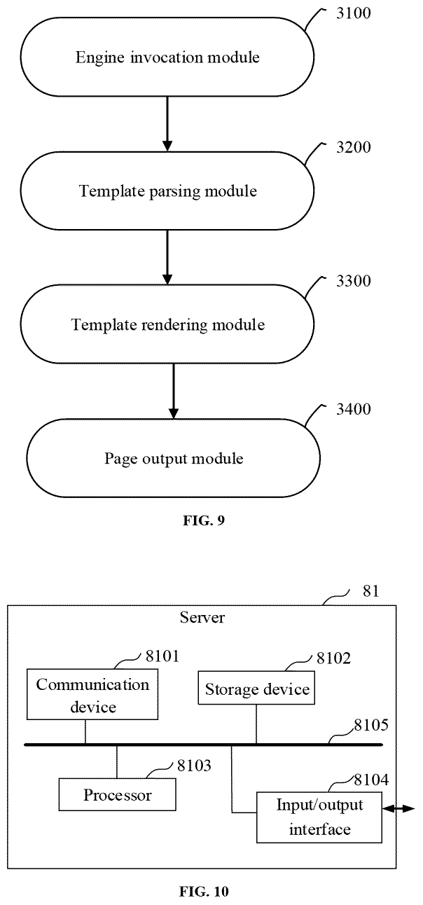

Please refer to FIG. 2. The method for rendering webpage of the present disclosure, in some of its embodiments, includes the following steps:

Step S3100: in response to a page access request sent by a client device, a template file is obtained according to a page identifier of a page to be accessed of the page access request by invoking a template engine developed based on a compiled language.

Taking an e-commerce platform application scenario as an example, when a user accesses the e-commerce platform through a terminal device (such as a computer, a mobile phone, etc.), the client device sends the page access request containing the page identifier to the server to obtain the final page codes of the corresponding page. Taking a promotional email as an example, when a recipient opens an email, the terminal device similarly initiates a page access request containing a page identifier to obtain the final page codes required to display the email. The page identifier is used to uniquely determine the specific page content requested by the user, for example, it could be a product detail page, a shopping cart page, or a checkout page, etc. After receiving the request, the server obtains the corresponding template file based on the page identifier, and then invokes the template engine developed based on the compiled language to perform rendering of the template file to generate the corresponding webpage.

The template engine of the present disclosure may be developed and implemented based on compiled language like Golang. Compared to traditional interpreted template engine, the template engine implemented based on compiled languages have higher execution efficiency and stronger business processing capabilities. Before the compiled language is executed, the compiled language will compile the code into machine code, then the compiled language will be executed faster at runtime. This enables the template engine to significantly improve efficiency when processing complex template files. In high-concurrency scenarios of the e-commerce platform, such an efficient template engine may quickly respond to the request from the client device, thereby enhancing user experience.

The template file is a pre-defined template for page structure and content, containing information such as page layout, styles, and placeholders for dynamically inserted data. For example, a template file for a product detail page may contain a display position of a product image, placeholders for the product name and price, etc. The template file is usually stored in a specific format, such as HTML template file embedded with syntax supported by the template engine.

Step S3200: an abstract syntax tree is generated by parsing the template file through the template engine, the abstract syntax tree representing logical relationship information among a mixed operation expression, a variable scope, a predefined tag, a business data filter, and a control statement of the template file.

After receiving the page access request sent by the client device and obtaining the corresponding template file, the template engine will parse the template file to generate an abstract syntax tree (AST). The abstract syntax tree is a tree data structure used to represent syntactic structure of source code. It may clearly express various logical relationship information within the template file, including the mixed operation expression, the variable scope, the predefined tag, the business data filter, and the control statement.

The mixed operation expression in the template file refers to a complex expression contained in the template, which may include logical operation, comparison operation, arithmetic operation, etc. For example, in a product recommendation template, it may be necessary to calculate a priority of recommended products based on browsing history and purchase behavior of the user, which requires the use of mixed operation expression. When parsing the template file, the template engine identifies the mixed operation expression and represents the mixed operation expression as a node in the abstract syntax tree, while also recording a relationship between an operator and an operand within the expression for subsequent priority parsing and syntax verification.

The variable scope refers to a range within the template file where a variable is valid. In a template file, a variable may be defined and used in different scopes, such as a local variable, a global variable, etc. When parsing the template file, the template engine determines the scope of the variable based on definition and usage locations, and adds scope information to each variable node in the abstract syntax tree. This way, in the subsequent data binding phase, the template engine may accurately find and bind variables based on scope information, avoiding variable conflicts and undefined errors.

The predefined tag is a special syntax in the template file, in forms such as {{#tag . . . /}} or {{#tag}} {{/tag}}. The predefined tag allows developers to define their own tags to implement specific functions, including but not limited to logic control (e.g., if, for, switch) and UI display (e.g., carousel functionality). For example, a {{#carousel/}} tag may be defined to implement a carousel function, or a {{#pagination/}} tag may be defined to implement pagination functionality. When parsing the template file, the template engine identifies the tags and represents them as nodes in the abstract syntax tree. At the same time, the template engine records information such as the name, attributes, and content of the predefined tags for subsequent semantic verification and rendering.

The business data filter is a component in the template file used to process business data. The business data filter may perform operations such as formatting, conversion, or validation on business data to ensure the data meets requirements of the template. For example, in a product list template, it may be necessary to format the product price to display it as a currency with two decimal places. When parsing the template file, the template engine identifies invocations of business data filters and represents them as nodes in the abstract syntax tree. Simultaneously, the template engine records information such as filter name and parameters for subsequently invoking the filter to process business data.

The control statement is syntactic structure in the template file used to control the template rendering flow, such as conditional statement (if), loop statement (for), selection statement (switch), etc. The syntactic structure may be implemented in the form of the predefined tag. When parsing the template file, for control statement represented by the predefined tag, the template engine will also identify them according to the syntax of the control statement and represent them as a node in the abstract syntax tree. At the same time, the template engine records information such as the syntax and logical structure of the control statement for subsequent verification and rendering. For example, in a product list template, a loop statement might be used to traverse product data and generate a product list, while a conditional statement might be used to determine whether to display promotional information for a certain product.

Step S3300: a static verification and optimization is performed on the logical relationship information of the template file by the template engine based on the abstract syntax tree, and optimized rendering codes is obtained by binding business data obtained from a data source to corresponding variables in the template file according to the correspondence between variables and business data.

After completing the parsing of the template file and generating the abstract syntax tree (AST), the template engine will perform the static verification and optimization on the logical relationship information in the template file based on the AST, bind business data obtained from the data source to the corresponding variables in the template file, and finally obtain the optimized rendering codes.

When parsing the template file, the template engine may perform priority parsing and syntax verification on the mixed operation expression, covering logical, comparison, and arithmetic operators. By analyzing expression nodes in the abstract syntax tree (AST), the template engine determines operator precedence and verifies correctness of the expression syntax. Furthermore, the template engine may, based on a scope chain of the variable established in the AST, verify whether the definition and invocation of variables comply with their scope rules, ensuring the correct use of local and global variables. The template engine may also perform semantic verification on the predefined tag, verifying whether the attribute and content comply with predefined rules, for example, checking whether the items attribute of the {{#carousel/}} tag exists and is in the correct format. Simultaneously, the template engine may verify the invocation interface of business data filters, ensuring the use of filters complies with predefined rules, such as verifying whether the invocation of the currency filter is correct. Finally, the template engine may also verify the syntax and logical structure of the control statement (such as if, for, switch), ensuring the syntax is correct and logic is reasonable, for example, verifying the syntax of a for loop and the logical condition of an if statement. After completing the above static verification and optimization, the template engine will bind business data obtained from the data source to the corresponding variables in the template file. The data source may be a database, API, cache, etc., providing the business data required for webpage rendering. The template engine binds data to variables in the template according to the correspondence between variables and business data. For example, the item Name variable in the product detail page template will be bound to the name data of the corresponding product in the database.

Through static verification optimization and data binding operations, the template engine generates optimized rendering codes, preparing for the next step of generating the final page codes. Accordingly, this not only improves the efficiency of page rendering but also ensures the accuracy and stability of the rendering results.

Step S3400: final page codes is generated by using the template engine to generate the final page codes based on the optimized rendering codes and remove redundant information of the final page codes, and the final page codes is sent to the client device for rendering and displaying.

After completing the parsing of the template file, generating the abstract syntax tree (AST), and performing AST-based static verification, optimization, and data binding, the template engine enters the page code generation phase. The goal is to convert the optimized rendering codes into the final HTML page code and send it to the client device for rendering and displaying.

Specifically, the template engine first generates the HTML codes of the page based on the optimized rendering codes. This process involves replacing placeholders like variables in the template file with actual business data, while preserving the HTML structure and styles defined in the template file. For example, in response that the template file includes a placeholder for a product list, the template engine will replace the placeholder item by item with the product data obtained from the data source, generating complete HTML list code.

The template engine also performs optimization processing on the HTML codes, removing whitespace characters and comments that constitute redundant information. In the template file, developers may add comments to explain function or structure of the code, but in the final HTML codes, these comments are unnecessary and increase the amount of data transmitted for the page. By removing the redundant information, the template engine may generate more concise and efficient HTML codes, speeding up page loading. For example, the template engine will replace consecutive whitespace characters with a single space and remove comment lines from the HTML codes, thereby reducing the size of the HTML file.

Finally, the template engine sends the optimized HTML codes as the final page codes to the client device for rendering and displaying. After receiving the HTML codes, a browser of the client device will parse and render the code, displaying the webpage content to the user. This not only improves the page loading speed but also enhances the page display effect and user experience by optimizing the HTML codes structure and content.

Through the above embodiments, the present disclosure, based on a template engine developed with a compiled language, comprehensively optimizes the template file rendering process and achieves abundant beneficial technical effects, including but not limited to:
First, by adopting a template engine developed based on a compiled language, the present disclosure effectively improves the efficiency of rendering webpage. Compiled languages have significant advantages in execution efficiency compared to traditional interpreted languages. In high-concurrency scenarios, the efficient template engine may quickly parse template files and bind business data, thereby significantly accelerating page rendering speed, reducing waiting time for the user, and thus enhancing user experience. This efficient rendering mechanism allows the e-commerce platform to maintain smooth page loading during high-traffic access, enhancing stability and reliability of the platform.
Second, the present disclosure introduces the a static verification and optimization mechanism for logical relationship information in template files. By constructing the abstract syntax tree during the template parsing phase and performing verification on logical relationships such as variable scope, mixed operation expressions, predefined tags, business data filters, and control statements in the template based on the tree, potential errors may be detected and corrected in advance during the rendering stage. The static verification mechanism avoids errors caused by runtime checks in traditional technologies, ensuring the accuracy and stability of page rendering. In the e-commerce platform, the mechanism may effectively prevent incorrect display of transaction information, ensure the security and accuracy of transactions, and simultaneously reduce the risk of user churn due to errors.

Furthermore, the template engine of the present disclosure, developed based on the compiled language, has high business capabilities. When generating the final page codes from the rendering code, it may perform redundant information cleanup, removing excess whitespace characters and comments. The generated HTML codes is more concise and efficient, reducing the amount of data transmitted for the page and speeding up page loading. In the e-commerce platform, the optimization processing not only improves page response speed but also reduces server bandwidth consumption, improving the overall operational efficiency of the platform.

Based on any embodiment of the method of the present disclosure, performing the static verification and optimization on the logical relationship information in the template file includes any one or any combination of the following:

Step S3301: priority parsing and syntax verification is performed on the mixed operation expression of the template file to determine that the mixed operation expression complies with operation rule.

After completing the parsing of the template file and generating the abstract syntax tree (AST), the template engine enters the a static verification and optimization stage. An optional key operation is to perform priority parsing and syntax verification on the mixed operation expression of the template file to ensure that the expression of the template may be executed correctly during the rendering stage, avoiding page rendering failure or abnormal display due to syntax errors or logical problems.

As revealed earlier, the mixed operation expression refer to complex expression contained in the template file, which may involve logical operations, comparison operations, arithmetic operations, etc. For example, in a product recommendation template, it may be necessary to calculate the priority of recommended products based on browsing history and purchase behavior of the user, which requires the mixed operation expression. When parsing the template file, the template engine identifies the mixed operation expression and represents the mixed operation expression as a node in the abstract syntax tree, while also recording the relationships between the operator and the operand within the expression for subsequent priority parsing and syntax verification.

Specifically, the template engine analyzes the node of the AST, determines priority of the operator, and checks whether the syntax of the expression is correct. For example, for the expression “if (user.bought(item)&& item.rating>4)”, the template engine parses the expression, ensuring that the use of the logical operator “&&” and the comparison operator “>” complies with the syntax rule, and that the invocations of the operand “user.bought (item)” and “item.rating” are valid. In this way, the template engine may detect and correct potential syntax error in advance, ensuring the expression executes correctly at runtime.

Furthermore, the template engine also performs semantic verification on variables and function invokes of the expression. For example, the template engine checks whether the variables “user” and “item” have been defined in the template file and whether their scopes are correct. Simultaneously, the template engine verifies whether the functions “bought” and “rating” exist and whether the parameters meet expectations. Semantic verification may further ensure the correctness and reliability of the expression.

In practical applications, the mixed operation expression may take various specific forms. For example, in a product detail page template, it may be necessary to display different information based on stock quantity of the product and purchase permission of the user. The template engine would parse an expression like “if (item.stock>0 && user.has_permission)”, ensuring logic of the expression is correct and complies with the syntax rule. In another scenario, the template engine might process expressions involving arithmetic operation, such as “total_price=item.price*item.quantity”, ensuring use of the multiplication operator “*” is correct and that the value of the variable “item.price” and “item.quantity” are valid numeric types.

Through the above priority parsing and syntax verification operations, the template engine may ensure that the mixed operation expression of the template file is executed correctly during the rendering stage. The static verification mechanism not only improves the efficiency of webpage rendering but also ensures the accuracy and stability of the rendering results, providing an efficient and reliable page rendering solution for the e-commerce platform. This process is an important part of the static verification and optimization of the template engine, ensuring that the logical relationship information in the template file is fully verified and optimized before rendering.

Step S3302: Based on the scope chain of the variable established during the template file parsing phase and represented in the abstract syntax tree, the definition and invocation of the variable are verified to ensure compliance with the scope rule.

In the template file parsing phase described earlier, the template engine established the scope chain for the variable based on the abstract syntax tree (AST). The scope chain is used to ensure that the definition and invocation of variable in the template file comply with the scope rule. Specifically, through the scope chain, the template engine may clarify the scope range of each variable, thereby accurately locating and binding variable during the data binding phase, avoiding variable conflict and undefined error.

The scope chain of the variables is established by determining the scope of the variable through template engine based on the definition location and usage location of the variable when parsing the template file. For example, in a template file, the local variable is only valid within specific code block, while the global variable is accessible throughout the entire template file. The template engine adds scope information to each variable node and constructs a hierarchical structure in the AST, namely the scope chain. In this way, during the subsequent data binding phase, the template engine may quickly locate the definition location of the variable based on the scope chain, ensuring the correct use of the variable.

During the static verification and optimization phase, the template engine uses the scope chain to verify the definition and invocation of the variable. For example, in a product detail page template, the local variable “itemPrice” might only be valid within the product price display section. The template engine will use the scope chain to ensure that the variable is not erroneously referenced outside this section. This verification mechanism can detect variable usage errors in advance, avoid runtime errors, and ensure the accuracy and stability of page rendering.

Furthermore, based on the scope chain, the template engine may implement more complex verification logic. For example, the template engine may detect whether the variable is defined repeatedly or whether the variable is used without being defined. The verification logic can be implemented by traversing the scope chain, ensuring that the use of variables in the template file complies with predefined rules.

By establishing and utilizing the scope chain of the variable, the template engine may effectively perform the static verification and optimization, ensuring that the definition and invocation of the variable in the template file comply with the scope rule. This mechanism not only improves the maintainability and readability of the template file but also enhances the accuracy and stability of rendering webpage by detecting potential errors in advance, providing an efficient and reliable webpage rendering solution for the e-commerce platform.

Step S3303: semantic verification is performed on the predefined tag to determine whether the predefined tag complies with a first predefined rule.

The template engine may perform semantic verification on the first predefined tag in the template file to ensure that the use of the predefined tag complies with the first predefined rule, thereby guaranteeing the correctness of the template file and the stability of rendering result.

As revealed earlier, the predefined tags is a special syntax in the template file, in forms such as “{{#tag . . . /}}” or “{{#tag}} {{/tag}}”, allowing developers to define their own tags to implement specific functions. For example, a tag “{{#carousel/}}” may be defined to implement a carousel function, or a tag “{{#pagination/}}” may be defined to implement pagination functionality. The predefined tag usually has specific attribute and content structure, and the template engine needs to ensure the predefined tag compliance with the first predefined rule.

During the template file parsing phase, the template engine identifies all predefined tags and represents them as nodes in the abstract syntax tree (AST). Simultaneously, the template engine records information such as the name, attributes, and content of each predefined tag. For example, the template file might include a tag “{{#carousel/}}” used to implement the carousel function. The template engine parses the tag and creates a corresponding node in the AST, recording the name as “carousel”, “items” and “autoplay” as attributes, and the content of sub-tag “{{#item/}}”.

During the semantic verification phase, the template engine checks whether the use of the predefined tag complies with predefined rule. The rule typically includes whether the attribute of the predefined tag is complete, whether the format of the attribute value is correct, whether structure of the sub-tag meets expectation, etc. For example, for the tag “{{#carousel/}}”, the template engine checks the following points:
1. Attribute completeness: The template engine checks whether the tag “{{#carousel/}}” contains required attribute “items”, which is used to specify a list of items for the carousel. If the attribute is missing, the template engine will report an error, prompting the developer to correct the template file.
2. Attribute value format: The template engine checks whether the value of the attribute “items” conforms to an expected format. For example, the value of the attribute “items” should be a variable that is defined in the template file and points to an array containing carousel item data. If the value of the attribute “items” does not meet the expected format, the template engine will report an error and prompt the developer to correct it.
3. Sub-tag structure: The template engine checks whether the sub-tag “{{#item/}}” of the tag “{{#carousel/}}” conforms to an expected structure. For example, the sub-tag “{{#item/}}” should contain a tag “<img>” to display the image of the carousel. If the tag “<img>” is missing within the sub-tag “{{#item/}}”, the template engine will report an error and prompt the developer to correct it.
4. Logical structure verification: For logical control syntax (like “If”, “for”, “switch”), the template engine checks whether the syntax and logical structure comply with predefined language rule. For example, whether the conditional expression of an “if”′ statement is a valid Boolean expression, whether the iteration condition of a “for” loop is clear and legal, and whether a branch structure of a “switch” statement is correct.

Through semantic verification, the template engine may ensure that the use of predefined tag complies with the predefined rule, thereby avoiding runtime error and ensuring the accuracy and stability of page rendering. This verification mechanism not only improves the maintainability and readability of the template file but also enhances the accuracy and stability of page rendering by detecting potential errors in advance, providing an efficient and reliable webpage rendering solution for e-commerce platforms.

Furthermore, during the semantic verification phase, the template engine may implement more complex verification logic. For example, the template engine may detect whether the predefined tag is correctly nested or whether certain attributes are used in inappropriate locations. These verification logics may be implemented by traversing the abstract syntax tree, ensuring that the use of the predefined tag in the template file complies with the predefined rule.

By identifying the predefined tag and performing semantic verification, the template engine may effectively perform the static verification and optimization, ensuring that the definition and use of the predefined tag in the template file comply with the predefined rule. This mechanism not only improves the maintainability and readability of the template file but also enhances the accuracy and stability of page rendering by detecting potential errors in advance, providing an efficient and reliable webpage rendering solution for the e-commerce platform.

Step S3304: the invocation interface of the business data filter is verified to determine if the invocation interface of the filter complies with a second predefined rule, the business data filter being invoked to process the business data for binding to the variable.

The template engine may also verify the invocation interface of the business data filter to ensure that the use of business data filter complies with the second predefined rule, thereby guaranteeing the correctness of the template file and the stability of the rendering result.

Business data filters are components in the template file used to process business data. They can perform operations such as formatting, conversion, or validation on data to ensure the data meets the template's requirements. For example, a ‘currency’ filter can be defined to format numbers into currency format, or a ‘truncate’ filter can be defined to truncate long text. The template engine needs to ensure that the invocation interfaces of these filters comply with predefined rules to avoid runtime errors.

During the template file parsing phase, the template engine identifies all invocations of the business data filter and represents them as nodes in the abstract syntax tree (AST). Simultaneously, the template engine records information such as the name, parameters, and invocation location of each filter. For example, the template file might contain the following filter invocations:

<div>
Product price: {{ item.price | currency ( ) }}
Product description: {{ item.description | truncate: (50) }}
</div>

In this example, “currency” and “truncate” are business data filters, used to format the product price into currency format and truncate the product description, respectively. The template engine parses these filter invocations and creates corresponding nodes in the AST, recording their names, parameters, and invocation locations.

During the invocation interface verification phase, the template engine checks whether the use of the business data filter complies with the second predefined rule. The second predefined rule typically includes whether the filter exists, whether the number and type of parameters are correct, whether the invocation location is reasonable, etc. For example:
1. Filter existence check: The template engine checks whether the invoked filter has been defined. For example, if the filter “currency” is invoked in the template, the template engine verifies whether the filter is registered in the system. If it is not defined, an error is reported during the static verification phase, avoiding runtime errors.
2. Parameter check: The template engine checks whether the number and type of the parameters of the filter comply with the second predefined rule. For example, the filter “truncate” might require an integer parameter to specify the truncation length. The template engine verifies whether the correct parameter type and number are provided during invocation. If the parameters do not comply with the second predefined rule, the template engine reports an error during the static verification phase.
3. Invocation location check: The template engine checks whether the invocation location of the filter is reasonable. For example, some filters might only be usable in specific contexts. The template engine verifies whether the invocation location complies with the second predefined rule. If the invocation location is unreasonable, the template engine reports an error during the static verification phase.

Through the above verification mechanism, the template engine may ensure that the use of the business data filter complies with the second predefined rule, thereby avoiding runtime errors during the template rendering stage and improving the maintainability and readability of the template file. This static verification mechanism not only improves the correctness of the template file but also enhances the accuracy and stability of webpage rendering by detecting potential errors in advance, providing an efficient and reliable webpage rendering solution for the e-commerce platform.

Step S3305: the syntax and logical structure of the control statement is verified and whether expression of the control statement complies with a preset language rule is determined.

The template engine may also verify the control statement of the template file. Through the verification, it ensures that the syntax and logical structure of the control statement comply with predefined language rules, thereby guaranteeing correctness of the template file and stability of the rendering results.

The control statement is syntactic structure of the template file used to control the template rendering flow, such as a conditional statement (e.g., if or else), a loop statement (e.g., for or while), and a selection statement (e.g., switch or case). The correct use of the control statement is crucial for the logical execution of the template. When parsing the template file, the template engine identifies the control statement and represents the control statement as a node in the abstract syntax tree (AST), while also recording information such as the syntax and logical structure of the control statement.

During the template file parsing phase, the template engine identifies all control statements and creates corresponding nodes in the AST. For example, the template file might contain the following control statements:

{{#if item.price > 100}}
<p>High Price Item</p>
{{#else}}
<p>Low Price Item</p>
{{/if}}

In this example, {{# if item.price>100}} is a conditional statement. The template engine parses the conditional statement and creates a corresponding node in the AST, recording a conditional expression “item.price>100” and a corresponding branch content.

During the semantic verification phase, the template engine checks whether the syntax of the control statements is correct and whether the logic is reasonable. These verification rules typically include:

### 1. Conditional Statement Verification:

The template engine checks whether the conditional expression of the conditional statement complies with syntax rules. For example, the conditional expression of an “if” statement should be a valid Boolean expression.

The template engine also checks whether the “if” statement contains a legal branch structure, such as else branch or elif branch, and ensures the syntax of the branches is correct.

### 2. Loop Statement Verification:

The template engine checks whether an iteration condition of the loop statement complies with syntax rules. For example, the iteration variable and iteration range of a for loop should be clear and legal.

The template engine also checks whether the content within the loop body conforms to logic, such as whether there are legal variable references and expressions.

### 3. Selection Statement Verification:

The template engine checks whether the syntax of the selection statement (e.g., switch or case) is correct. For example, a switch statement should contain a valid expression, and a case branch should contain legal values.

The template engine also checks whether the case branch is correctly nested within the switch statement and ensures that the syntax and logical structure of each case branch comply with the rules.

For example, the template file might include the following selection statement:

```
{{#switch item.type}}
  {{#case “book”}}
    <p>This is a book. </p>
  {{/case}}
  {{#case “electronics”}}
    <p>This is an electronic product. </p>
  {{/case}}
  {{#default}}
    <p>Unknown item type. </p>
  {{/default}}
{{/switch}}
```

In this example, the template engine parses the selection statement {{#switch item.type}} and creates a corresponding node in the AST, recording its expression “item.type” and the content of each case branch. The template engine checks whether each case branch is correctly nested within the switch statement and ensures that the value of each case branch is legal.

Through the above verification mechanism, the template engine may ensure that the syntax and logical structure of the control statement complies with the predefined language rules, thereby detecting potential errors in advance, avoiding runtime errors, and ensuring the accuracy and stability of webpage rendering. This static verification mechanism not only improves the maintainability and readability of the template file but also enhances the accuracy and stability of webpage rendering by detecting potential errors in advance, providing an efficient and reliable webpage rendering solution for the e-commerce platform.

Based on any embodiment of the method of the present disclosure, binding the business data obtained from the data source to the corresponding variables in the template file comprises:

Step S3311: business data related to a page to be accessed is obtained from the data source according to a correspondence relationship between the variable and the business data.

Before binding the business data to the corresponding variables in the template file, the template engine first obtains business data related to the page to be accessed from the data source based on the correspondence relationship between the variable and the business data, ensuring that the template engine may obtain the correct data to complete webpage rendering.

Specifically, the template file defines multiple variables, and the variables need to obtain corresponding values from the data source in backend service. The data source may be a database, an API interface, a cache system, or any other form of storage system, providing the business data required for webpage rendering. By parsing the template file, the template engine identifies the name and type of each variable and queries the corresponding data from the data source based on the information.

For example, suppose the template file contains a variable “itemPrice” used to display the product price. When parsing the template file, the template engine identifies the “itemPrice” variable and obtains the value corresponding to the variable from the data source according to a predefined mapping relationship. If the data source is a database, the template engine might execute an SQL query statement to obtain the product price; if the data source is an API interface, the template engine might send an HTTP request to obtain the data.

In a practical application, the correspondence relationship between the variable and the business data may be defined in multiple ways. One common way is to explicitly declare the data source path or API interface address of the variable in the template file. For example, the template file might contain a declaration like:

$$\{ \{ \# set itemPrice = “ / api / items / 123 / price ” / \} \}$$

A path of the data source for the variable “itemPrice” is defined as “/api/items/123/price”. The template engine will obtain the data from the API interface based on the path.

Another way is to define the relationship between the variable and the data source through mapping rules in configuration files or code. For example, the configuration file might contain mapping rules like:

```
{
  “itemPrice”: “/api/items/123/price”,
“itemName”: “/api/items/123/name”
    }
```

When parsing the template file, the template engine obtains the corresponding data from the data source based on the mapping rules.

Furthermore, the template engine may also support the generation of dynamic data source paths. For example, dynamically constructing the data source path based on user input or contextual information. Suppose the template file contains a variable “userId” used to identify the current user. The template engine may dynamically generate the path based on the “userId”, thereby obtaining data related to the current user.

Step S3312: a business data filter is invoked to process the business data, the business data filter being used to format, convert, or validate the business data.

After obtaining the business data related to the page to be accessed, the template engine invokes the business data filter to process the business data. The business data filter may be used to format, convert, or validate the business data, ensuring that the data conforms to the expected format and logic before being bound to template variables.

The main purpose of the business data filter is to preprocess the raw data obtained from the data source so that it may better adapt to the requirements of the variables in the template file. This preprocessing includes, but is not limited to, data formatting, data type conversion, data validation, and other operations. Through these operations, the template engine may ensure that the data bound to template variables is accurate and usable, thereby improving the stability and reliability of webpage rendering.

The business data filter may format data to make it conform to the display requirements of variables in the template file. For example, for product price data, a filter may format it into currency format. For instance, suppose the template file contains a variable “itemPrice” used to display the product price. The price data obtained by the template engine from the data source is “1234.56”, but the template file requires it to be displayed in currency format. At this point, the business data filter invokes a filter named “currency” to change a format of the price data into “$1,234.56”.

The filter may also perform type conversion on data to ensure the data type is consistent with the requirements of the template variable. For example, if a variable in the template file requires integer type data, but the data source returns a string type, the filter may convert the string to an integer. For example, converting the string “123” to the integer “123”.

The business data filter may also validate data to ensure its integrity and correctness. For example, for user-input form data, filters may verify whether the data conforms to the expected format and range. If the data does not meet the requirements, the filter may throw an error or return a default value, thereby preventing erroneous data from being bound to template variables.

The business data filter not only support static data processing rules but may also dynamically adjust processing logic based on contextual information. For example, suppose the template file contains a variable “userId” used to identify the current user. The template engine may dynamically generate the data source path based on the “userId” and obtain data related to the current user from the API interface. Simultaneously, the filter may further process the data based on the user's role or permissions. For example, for administrator users, the filter may provide more data fields, while for regular users, the filter may hide certain sensitive information. The invocation rules for the business data filter may be defined through mapping rules in configuration files or code. When parsing the template file, the template engine obtains the corresponding data from the data source based on the mapping rules and invokes the specified filter for processing.

Step S3313: data processed by the business data filter is bound to the variable in the template file and generating a variable value usable for rendering.

After completing the acquisition and filtering processing of the business data, the template engine enters a critical data binding phase. The goal of this phase is to accurately bind the data processed by the business data filter to the corresponding variables in the template file, thereby generating variable values usable for rendering, providing accurate data support for subsequent webpage rendering.

In the steps described earlier, the template engine has already obtained the relevant business data from the data source according to the correspondence relationship between the variable and the business data and processed the data through the business data filter for formatting, conversion, or validation. This processed data now needs to be bound to the variables defined in the template file. For example, suppose the template file defines a variable “itemPrice” used to display the product price. After obtaining and processing the price data corresponding to this variable, the template engine will bind the formatted price (e.g., “$1,234.56”) to the variable “itemPrice”.

When binding data, the template engine follows the definition and scope information of the variables in the template file to ensure the accuracy of data binding. If multiple variables exist in the template file, the template engine will bind the processed data to the corresponding variables one by one. For example, besides “itemPrice”, the template file might also define variables like “itemName”, “itemDescription”, etc. The template engine will bind the corresponding name and description data to these variables respectively.

Through the execution of the above embodiments, the present disclosure has achieved significant technical advantages. First, by obtaining business data related to the page to be accessed from the data source and binding it based on the correspondence relationship between the variable and the business data, it ensures that the template engine may obtain accurate and relevant data to complete webpage rendering. This process not only improves efficiency of data acquisition but also enhances maintainability and readability of the template file through clear mapping relationships. Second, invoking the business data filter to process the acquired business data further ensures that the data conforms to the expected format and logic before being bound to the template variable. This preprocessing mechanism, including data formatting, type conversion, and validation, not only improves the stability and reliability of webpage rendering but also enhances data security and consistency. Finally, binding the processed data to the corresponding variables in the template file to generate variable values usable for rendering ensure that the template engine may quickly and accurately generate the final page codes during the rendering stage, significantly improving webpage rendering speed and user experience. It can be seen that the implementation of the above steps not only improves the efficiency and accuracy of data processing but also provides an efficient, stable, and secure page rendering solution for the e-commerce platform by optimizing the data binding and preprocessing mechanisms.

Based on any embodiment of the method of the present disclosure, generating, by the template engine, the final page codes from the rendering code and removing redundant information, and sending the final page codes to the client device for rendering and displaying, comprises:

Step S3410: a HTML codes is generated for the page to be accessed based on optimized rendering codes.

The template engine generates the HTML codes for the page to be accessed based on the optimized rendering codes. The rendering code is the result obtained by the template engine in the previous steps through parsing the template file, binding business data, and performing the static verification and optimization. At this stage, the template engine converts the rendering code into specific HTML codes. This includes replacing variables and other placeholders in the template with actual business data, as well as generating corresponding HTML tag and content according to the logical structure defined in the template file. For example, if the template file contains a loop structure for a product list, the template engine will generate the HTML codes based on the business data.

Step S3420: an optimization processing on the HTML codes is performed by removing a whitespace character and comments from the redundant information.

The template engine performs optimization processing on the HTML codes, removing the whitespace character and the comments from the redundant information. In the template file, developers may add comments to explain function or structure of the code, but in final HTML codes, the comments are unnecessary and increase a amount of data transmitted for the page. By removing the redundant information, the template engine may generate more concise and efficient HTML codes, speeding up page loading. For example, the template engine will replace consecutive whitespace characters with a single space and remove comment lines from the HTML codes, thereby reducing the size of the HTML file.

Step S3430: an optimized HTML codes as final page codes is sent to the client device for rendering and displaying.

The template engine sends the optimized HTML codes as the final page codes to the client device for rendering and displaying. After receiving the HTML codes, the browser of the client device will parse and render the HTML codes, displaying the page content to the user. This process not only improves the page loading speed but also enhances the page display effect and user experience by optimizing the HTML codes structure and content.

Through the above steps, when generating the final page codes, the template engine of the present disclosure optimizes the transmission efficiency of the page by removing redundant information. This efficient and standardized page code generation mechanism provides the e-commerce platform with the ability to quickly respond to client device requests and efficiently render the webpage, thereby maintaining smooth user experience in high-concurrency access scenarios and enhancing stability and reliability of the platform.

Based on any embodiment of the method of the present disclosure, before generating, by the template engine, the final page codes from the rendering code and removing redundant information, the method further comprises:

Step S2100: a security check on the optimized rendering codes is performed to detect whether any target security vulnerability exists.

The template engine performs a security check on the rendering code to detect whether any target security vulnerabilities exist. This process may identify potential security issues, such as Cross-Site Scripting (XSS), Cross-Site Request Forgery (CSRF), or other common security vulnerabilities, through static analysis of the rendering code. For example, the template engine may check whether the rendering code contains unfiltered user input data directly inserted into the HTML codes, which could lead to XSS attacks. Through static analysis, the template engine may identify the potential security problem and record the location and type.

Step S2200: In response that a target security vulnerability exists, the optimized rendering codes combined with preset repair prompt text corresponding to the target security vulnerability is processed by a code repair model, and an automatic repair procedure for the optimized rendering codes is initiated.

When a target security vulnerability is detected in the rendering code, the template engine initiates the automatic repair procedure. The core of the automatic repair procedure is to combine the rendering code with preset repair prompt text targeted at that security vulnerability and process the automatic repair procedure by the code repair model. The code repair model may be a mature large language model with an ability to understand and generate code. It may make targeted modifications to the rendering code based on the input repair prompt text to eliminate security vulnerability.

The repair prompt text is generated based on a preset instruction template. The instruction template defines the specific operations and logic required to repair a particular security vulnerability. For example, for a Cross-Site Scripting (XSS) vulnerability, the instruction template might contain: “Perform HTML escaping on all user input data to ensure it properly escaped before being inserted into the HTML page.” The repair prompt text generates specific repair code snippets based on this instruction template, such as code calling an HTML escaping function.

After receiving the rendering code and the repair prompt text, the code repair model parses the vulnerability location in the rendering code and generates repaired code based on the repair prompt text. For example, if the rendering code contains unescaped data that is inputted by the user, the code repair model will insert an HTML escaping function at the corresponding location, ensuring the data is properly processed before being inserted into the HTML page. The repaired code will replace the original rendering code, thus completing the automatic repair procedure.

This automatic repair mechanism may not only quickly respond to detected security vulnerabilities, reducing the need for manual intervention, but also ensure the consistency and accuracy of repair measures. Through preset instruction templates and repair prompt text, the code repair model may generate corresponding repair code for different types of vulnerabilities, thereby improving the security and reliability of the template engine.

Step S2300: a secondary security check on the repaired rendering code is performed, and an alarm message in response that the target security vulnerability is detected again is outputted.

After the repair is completed, the template engine performs the secondary security check on the repaired rendering code to verify whether the repair was successful. This iterative inspection process ensures the effectiveness of the repair measures. If the target security vulnerability is detected again during the secondary check, the template engine will output the alarm message, notifying developers or system administrators to take further action. The alarm message may include a specific location and type of vulnerability, as well as repair suggestions, helping relevant personnel quickly locate and resolve the issue.

This embodiment significantly enhances the security and reliability of webpage rendering by introducing mechanisms for security checks, automatic repair, and secondary verification of the rendering code by the template engine. First, by using static analysis to detect target security vulnerabilities in the rendering code, such as XSS or CSRF, potential security risks may be identified in advance, preventing these vulnerabilities from being exploited, thereby protecting user data and platform security. Second, utilizing preset repair prompt text and a code repair model to automatically repair detected security vulnerabilities reduces the need for manual intervention, improves development efficiency, and ensures the accuracy and consistency of repair measures. Finally, through iterative security checks to verify the repair effect, it ensures that vulnerabilities are thoroughly resolved. If vulnerabilities are detected again, detailed alarm information is output, providing clear repair directions for developers or system administrators, further reducing security risks. Overall, this embodiment not only enhances page security but also improves development and operational efficiency through automated repair and verification mechanisms, providing a more stable and secure page rendering solution for the e-commerce platform.

Based on any embodiment of the method of the present disclosure, binding the business data obtained from the data source to the corresponding variables in the template file comprises:

Step S3321: historical behavior data of the user is obtained from a user behavior database according to a user identifier of the page access request.

The template engine obtains the historical behavior data of the user from the user behavior database according to the user identifier of the page access request. The user identifier may be a login ID of the user, a cookie, or other unique identifier used to retrieve the historical behavior records from the database. This historical behavior data may include browsing history, purchase records, favorites content, search keywords, etc. For example, an e-commerce platform may obtain the product categories the user has browsed and the product information the user has purchased in the past month from the database using the user identifier.

Step S3322: a personalized product recommendation list is generated by invoking a preset personalized recommendation algorithm based on the historical behavior data.

The template engine generates the personalized product recommendation list by invoking the preset personalized recommendation algorithm based on the historical behavior data. The personalized recommendation algorithm may be implemented based on collaborative filtering, content-based recommendation, hybrid recommendation, or other technologies. For example, a collaborative filtering algorithm may recommend products based on the historical behavior of the user and the preferences of similar users. A content-based recommendation algorithm may generate a recommendation list based on product attributes and the user's historical interests. These algorithms typically consider multiple factors, such as the user's purchase frequency, browsing duration, ratings, etc., to generate the product recommendation list that best matches interests of the user.

Step S3323: the personalized product recommendation list is formatted according to a preset business data filter of the template file.

After generating the personalized product recommendation list, the template engine formats the recommendation list according to the preset business data filter in the template file. The purpose of the business data filter is to format, convert, or validate the data in the recommendation list to ensure it meets the requirements of the template file. For example, the filter may format the product price into currency, truncate product names to a certain length, or sort the recommendation list. The filter may dynamically adjust the processing logic based on configurations in the template file or predefined rules to adapt to different display needs.

Step S3324: a formatted product recommendation list is set as business data and the business data is bound to the variable of the template file.

The template engine sets the formatted product recommendation list as business data and binds the business data to the corresponding variables of the template file. The template file may contain one or more variables for displaying information about the recommended products. For example, the template file might have a variable “recommendedItems” for displaying the recommended product list. The template engine binds the processed recommendation list to the variables, enabling the dynamic display of personalized product recommendations during rendering the webpage.

In the embodiment, through the combination of the template engine, user historical behavior data, and the personalized recommendation algorithm, achieves accurate personalized product recommendations. It further processes the recommendation results through the business data filter and finally dynamically binds the processed recommendation list to the corresponding variables of the template file for rendering the webpage This process not only enhances the user experience by allowing users to quickly obtain product recommendations that match their personal interests but also increases the commercial value of the e-commerce platform by improving user purchase conversion rates and operational efficiency through precise recommendations. Simultaneously, the use of business data filter ensures the consistency of the recommendation data format, optimizes the page display effect, and further enhances the professionalism and credibility of the platform.

Based on any embodiment of the method of the present disclosure, the method further comprises:

Step S5100: After receiving page access requests sent by a client device in a high-concurrency scenario, the page access requests are sorted according to a preset priority rule and sequentially the template engine is invoked for rendering webpage according to a sorting order.

In the high-concurrency scenario of the e-commerce platform, such as product rush purchase events existed in the e-commerce platform, quickly responding to the page access requests and efficiently rendering webpages are key to enhancing user experience and ensuring smooth transactions. The present disclosure proposes an optimized processing mechanism for efficiently handling the page access requests sent by the client device.

When a front-end server of the e-commerce platform receives the page access requests sent by the client device, it sorts the page access requests according to the preset priority rule. The preset priority rule may be set based on various factors such as an urgency of the request, the historical behavior data of the user, a current server load, etc. For example, in a the high-concurrency scenario, requests from high-frequency purchase users or requests for purchasing popular product pages may be prioritized to ensure the critical requests receive faster response. After sorting is completed, the template engine of the present disclosure is invoked sequentially according to the sorting result to perform webpage rendering, generating the final page codes corresponding to each request.

Step S5200: a multi-threading mechanism for parsing multiple template files simultaneously is enabled when the template engine parses the template file corresponding to each request.

To further improve the efficiency of webpage rendering, when the template engine parses the template files corresponding to each request, it enables the multi-threading mechanism to achieve simultaneous parsing of multiple template files. By processing multiple template files in parallel, the total time consumed for template parsing is significantly reduced, thereby accelerating the speed of rendering webpage.

Specifically, for requests queued after sorting, the template engine assigns a thread to each request for parsing the corresponding template file. The threads may run simultaneously without interfering with each other. The multi-threaded mechanism not only improves parsing efficiency of template files but also reduces the time users wait for pages to load. Especially in high-concurrency rush purchase scenarios, it may significantly enhance user experience.

By enabling the multi-threading mechanism to parse multiple template files simultaneously, the template engine may fully utilize multi-core processing capabilities of the server, significantly improve parsing efficiency of the template files and reduce the waiting time for page rendering. This mechanism is not only applicable to the high-concurrency scenario but may also be widely used in other scenarios requiring quick response and efficient processing, such as online ticketing systems, limited-time flash sales, etc., providing users with a smoother and faster page loading experience.

Step S5300: static resource of the final page codes is cached when generating the final page codes corresponding to each request and reduces repeated request for the data source.

When generating the final page codes corresponding to each request, the template engine caches the static resource of the final page codes to reduce repeated request for the data source. The static resource refers to resource that do not change frequently during the page rendering process, such as CSS files, JavaScript files, images, etc. The static resource is often the same across multiple page requests, so caching them can significantly improve page loading efficiency and reduce server burden.

The static resource of the final page codes is cached in various ways. One common method is to use in-memory caching, storing the static resource in memory of the server. When subsequent requests require the same static resources, they may be directly retrieved from memory without needing to be loaded again from the data source, greatly reducing response time. For example, for a product detail page of an e-commerce platform, its page layout and styles are usually controlled by the same CSS file. By caching the CSS files in the memory, subsequent page requests may be responded to quickly.

Another implementation method is to use a distributed caching system, such as Redis or Memcached. The distributed caching system may store the static resource across multiple server instances, suitable for the e-commerce platform with distributed architectures. When a request requires a certain static resource, the template engine first queries the distributed caching system. If the resource exists in the cache, it is returned directly; if the resource does not exist, it is loaded from the data source and simultaneously stored in the caching system for direct use by subsequent request.

Furthermore, Content Delivery Networks (CDNs) may be combined to further optimize the caching and distribution of static resources. CDNs may cache the static resource on an edge server closer to the user, thereby reducing latency of user requests for resources. For example, for a global e-commerce platform, by caching images and CSS files on CDN nodes around the world, it may ensure that users may quickly load the resources regardless of their location.

In practical applications, a caching strategy may be flexibly configured based on the update frequency and importance of resources. For example, for frequently updated resources, a shorter cache time may be set. For resources that change infrequently, a longer cache time may be set. Simultaneously, the template engine may also dynamically adjust the caching strategy based on the priority of requests and user behavior data to achieve optimal performance optimization.

Through the above caching processing mechanism, the template engine may not only reduce repeated request for the data source and improve page loading speed but also effectively reduce server load, enhancing the performance and user experience of the e-commerce platform.

Step S5400: a generated final page codes is sent to the client device corresponding to each request after compression processing.

After generating the final page codes corresponding to each request, the template engine performs compression processing on the final page codes to reduce the amount of data transmitted for the page and speed up page loading. Compression processing is achieved by removing redundant information such as extra whitespace characters, comments, line breaks, etc., from the HTML codes, resulting in more compact HTML codes. For example, the original HTML codes might contain multiple lines of comments and multiple consecutive spaces, all of which will be removed during compression, significantly reducing the size of the final HTML file.

Furthermore, the template engine may perform further compression on the static resource (e.g., CSS and JavaScript file) within the page. For example, by merging multiple CSS files or JavaScript files into one file, reducing the number of HTTP requests. Or by using tools (e.g., UglifyJS or CSSNano) to compress the code of the files, remove unnecessary spaces, comments, and redundant code, further reducing file size. For example, a page containing multiple JavaScript files may be compressed and merged into one file, reducing the time the browser takes to load these resources.

After completing the compression processing, the template engine sends the optimized page code to the respective client devices corresponding to each request. This process may be implemented using various technologies, such as using the HTTP/2 protocol to send the page. The HTTP/2 protocol supports multiplexing and server push features, which may significantly improve page loading speed. The server push feature allows the server to send the page code and related resources to the client device before the client device requests the page, thereby reducing client device waiting time. For example, when a client device requests a product detail page, the server may preemptively send the HTML codes, CSS files, and JavaScript files of that page, enabling the client device to load and render the page faster.

In at least one embodiment, through a series of optimization measures, significantly improves the efficiency for rendering webpage and user experience of the e-commerce platform in high-concurrency scenarios. First, by sorting client device page access requests according to preset priority rules, it ensures that critical requests (such as those from high-frequency purchase users or for popular product pages) receive faster responses, thereby ensuring transaction smoothness. Second, the template engine enables a multi-threading mechanism to parse multiple template files simultaneously, fully utilizing the multi-core processing capabilities of the server, significantly reducing template parsing time, and accelerating speed for rendering the webpage. Furthermore, caching the static resource of the final page codes reduces repeated requests to the data source, alleviating server burden, while further optimizing resource distribution through flexible caching strategies and CDN technology, improving page loading efficiency. Finally, compressing the generated final page codes further reduces the amount of data transmitted. Combined with the multiplexing and server push features of the HTTP/2 protocol, the page code is quickly sent to the client device, significantly speeding up page loading. These measures work together not only to enhance the user experience but also to improve the stability and reliability of the e-commerce platform in high-concurrency scenarios, providing an efficient page rendering solution.

Please refer to FIG. 3. An apparatus for rendering a webpage provided according to an aspect of the present disclosure includes an engine invocation module 3100, a template parsing module 3200, a template rendering module 3300, and a page output module 3400. Among them, the engine invocation module 3100 is configured to obtain a template file according to a page identifier of a page to be accessed of the page access request by invoking a template engine developed based on a compiled language in response to a page access request sent by a client device; the template parsing module 3200 is configured to an abstract syntax tree by parsing the template file through the template engine, the abstract syntax tree representing logical relationship information among a mixed operation expression, a variable scope, a predefined tag, a business data filter, and a control statement of the template file; the template rendering module 3300 is configured to perform a static verification and an optimization on the logical relationship information of the template file by the template engine based on the abstract syntax tree, and obtaining optimized rendering codes by binding business data obtained from a data source to corresponding variable in the template file according to the correspondence relationship between the variable and the business data; the page output module 3400 is configured to generate final page codes based on the optimized rendering codes through the template engine and remove redundant information from the final page codes and send the final page codes to the client device for rendering and displaying.

Based on any embodiment of the apparatus of the present disclosure, the template rendering module 3300 includes any one or any combination of the following modules: an expression verification module, configured to perform a priority parsing and a syntax verification on the mixed operation expression of the template file and determine that the mixed operation expression complies with an operation rule; a scope verification module, configured to, based on a scope chain of the variable established during a template file parsing phase and represented in the abstract syntax tree, verify a definition and an invocation of the variable that complies with a scope rule; a tag verification module, configured to perform a semantic verification on a predefined tag and determining whether the predefined tag complies with a first predefined rule; a filter verification module, configured to verify an invocation interface of a business data filter and determining whether the invocation interface of the business data filter complies with a second predefined rule, the business data filter being invoked to process the business data for binding to the variable; a statement verification module, configured to verify the syntax and logical structure of a control statement and determining whether expression of the control statement complies with a preset language rule.

Based on any embodiment of the apparatus of the present disclosure, the template rendering module 3300 includes: a data acquisition module, configured to obtain business data related to the page to be accessed from the data source according to a correspondence relationship between the variable and the business data; a data filtering module, configured to invoke a business data filter to process the business data, wherein the business data filter being used to format, convert, or validate the business data; a variable assignment module, configured to bind data processed by the business data filter to the variable in the template file, and generate a variable value usable for rendering.

Based on any embodiment of the apparatus of the present disclosure, the page output module 3400 includes: a code generation module, configured to generate HTML codes for the page to be accessed based on the optimized rendering codes; a redundancy optimization module, configured to perform optimization processing on the HTML codes to remove whitespace characters and comments from the redundant information; a page send module, configured to send the optimized HTML codes as the final page codes to the client device for rendering and displaying.

Based on any embodiment of the apparatus of the present disclosure, preceding the page output module 3400, it further includes: a vulnerability detection module, configured to perform a security check on the optimized rendering codes and detecting whether the optimized rendering codes have any target security vulnerability; an automatic repair module, configured to, in response that the optimized rendering codes have a target security vulnerability, process the optimized rendering codes combined with preset repair prompt text corresponding to the target security vulnerability by a code repair model, and initiate an automatic repair procedure for the optimized rendering codes; a vulnerability recheck module, configured to perform a secondary security check on repaired rendering code, and outputting an alarm message in response that the target security vulnerability has been detected again.

Based on any embodiment of the apparatus of the present disclosure, the template rendering module 3300 includes: a data invoke module, configured to obtain historical behavior data of a user from a user behavior database according to a user identifier of the page access request; a product recommendation module, configured to generate a personalized product recommendation list by invoking a preset personalized recommendation algorithm based on the historical behavior data; a list filtering module, configured to format the personalized product recommendation list according to a preset business data filter of the template file; a variable binding module, configured to set a formatted product recommendation list as the business data and bind the business data to the variable of the template file.

Based on any embodiment of the apparatus of the present disclosure, the apparatus further includes: a request queuing module, configured to, after receiving page access requests sent by the client device in the high-concurrency scenario, sort t the page access requests according to a preset priority rule and invoke the template engine for rendering webpage according to a sorting order; a parallel processing module, configured to enable a multi-threading mechanism for parsing a plurality of template files simultaneously when the template engine parses the template file corresponding to each request of the page access requests; a cache processing module, configured to cache static resources in the final page codes when generating the final page codes corresponding to each request, to reduce repeated requests to said data source; a compression transmission module, configured to send a generated final page codes to the client device corresponding to each request after performing a compression processing the generated final page codes.

As shown in FIG. 10, the server 81 includes a communication device 8101, a storage device 8102, a processor 8103, an input/output (I/O) interface 8104 and a bus 8105. The processor 8103 is coupled to the communication device 8101, the storage device 8102, and the input/output interface 8104 through the bus 8105, respectively.

The communication device 8101 may be a wireless communication device or a mobile communication device. The wireless communication device may provide wireless communication solutions applied to the server 81 including a wireless local area network (WLAN) (for example, wireless fidelity (Wi-Fi) network), a Bluetooth (BT), and a global navigation satellite system (GNSS), a frequency modulation (FM), a near field communication (NFC), an Infrared (IR) and other wireless communication solutions. The mobile communication device may provide wireless communication solutions including 2G/3G/4G/5G applied to the server 81.

The storage device 8102 may include one or more random access memories (RAM) and one or more non-volatile memories (NVM). The random-access memory may be directly read and written by the processor 8103, may be used to store executable programs (such as machine instructions) of the operating system or other running programs, and may also be used to store user data and application data, etc. The random-access memory may include a static random-access memory (SRAM), a dynamic random-access memory (DRAM), a synchronous dynamic random-access memory (SDRAM), a double data Rate Synchronous Dynamic Random-access memory (DDR SDRAM, for example, the fifth generation DDR SDRAM is generally called DDR5 SDRAM), etc.

The non-volatile memory may also store executable programs and user data and application data, etc., and may be loaded into the random-access memory in advance for direct reading and writing by the processor 8103. The non-volatile memory may include a disk storage device and a flash memory.

The storage device 8102 is used to store one or more computer programs. The one or more computer programs are configured for execution by processor 8103. The one or more computer programs include a plurality of instructions. When the plurality of instructions is executed by the processor 8103, the method for generating the vehicle parameters or the method for rendering a webpage executed on the server 81 may be implemented.

In other embodiments, the server 81 further includes an interface for connecting to an external storage device to expand a storage capacity of the server 81.

The processor 8103 may include one or more processing units. For example, the processor 8103 may include an application processor (AP), a modem processor, a graphics processing unit (GPU), and an image signal processor (ISP), a controller, a video codec, a digital signal processor (DSP), a baseband processor, and/or neural-network processing unit (NPU), etc. Among them, different processing units can be independent devices or the different processing units can be integrated in one or more processors.

The processor 8103 provides computing and control capabilities. For example, the processor 8103 is used to execute a computer program stored in the storage device 8102 to implement the method for generating the vehicle parameters or the method for configurating the vehicle parameters.

The I/O interface 8104 is used to provide a channel for user input or output. For example, the I/O interface 8104 can be used to connect various input and output devices, such as a mouse, a keyboard, a touch device, a display screen, etc., so that the user may input information, or make the information be visualized.

The bus 8105 is at least used to provide a channel for a mutual communication among the communication device 8101, the storage device 8102, the processor 8103, and the I/O interface 8104 in the server 81.

It can be understood that the structure illustrated in the embodiment of the present application does not constitute a specific limitation on the server 81. In other embodiments of the present application, the server 81 may include more or fewer components than shown in the figure, or some components may be combined, some components may be separated, or some components may be arranged differently. The components illustrated may be implemented in hardware, software, or a combination of software and hardware.

Embodiments of the present application also provide a computer-readable storage medium. A computer program is stored on the computer-readable storage medium. The computer program includes program instructions. The method implemented when the program instructions are executed may refer to the vehicle parking method or the vehicle finding method in each of the above embodiments.

The computer-readable storage medium may be an internal storage device of the computer device described in the above embodiment, such as a hard disk or a memory of the computer device. The computer-readable storage medium may also be an external storage device of the computer device, such as a plug-in hard disk, a smart media card (SMC), or a secure digital (SD) card, a flash card equipped on the computer device.

Further, the computer-readable storage medium may mainly include a storage program area and a storage data area, among them, the storage program area may store an operating system, an application program required for at least one function, etc.; the storage data area may store data created based on the use of the computer device.

Finally, it should be noted that the above embodiments are only used to illustrate the technical solutions of the present application and are not limiting. Although the present application has been described in detail with reference to the preferred embodiments, those of ordinary skill in the art should understand that the technical solutions of the present application can be modified. Modifications or equivalent substitutions may be made without departing from the spirit and scope of the technical solution of the present application.

What is claimed is:

1. A method for rendering a webpage, comprising:
in response to a page access request sent by a client device, obtaining a template file according to a page identifier of a page to be accessed of the page access request by invoking a template engine developed based on a compiled language;
generating an abstract syntax tree by parsing the template file through the template engine, the abstract syntax tree representing logical relationship information among a mixed operation expression, a variable scope, a predefined tag, a business data filter, and a control statement of the template file; and
performing a static verification and an optimization on the logical relationship information of the template file by the template engine based on the abstract syntax tree, and obtaining optimized rendering codes by binding business data obtained from a data source to corresponding variable in the template file according to the correspondence relationship between the variable and the business data; and
generating final page codes based on the optimized rendering codes through the template engine and removing redundant information from the final page codes and sending the final page codes to the client device for rendering and displaying.

2. The method according to claim 1, wherein the performing the static verification and optimization on the logical relationship information of the template file comprises any one or any combination of the following:
performing a priority parsing and a syntax verification on the mixed operation expression of the template file and determining that the mixed operation expression complies with an operation rule;
based on a scope chain of the variable established during a template file parsing phase and represented in the abstract syntax tree, verifying a definition and an invocation of the variable that complies with a scope rule;
performing a semantic verification on a predefined tag and determining whether the predefined tag complies with a first predefined rule;
verifying an invocation interface of a business data filter and determining whether the invocation interface of the business data filter complies with a second predefined rule, the business data filter being invoked to process the business data for binding to the variable;
verifying the syntax and logical structure of a control statement and determining whether expression of the control statement complies with a preset language rule.

3. The method according to claim 2, wherein obtaining optimized rendering codes by binding business data obtained from a data source to corresponding variable in the template file according to the correspondence relationship between the variable and the business data comprises:
obtaining business data related to the page to be accessed from the data source according to a correspondence relationship between the variable and the business data;
invoking a business data filter to process the business data, wherein the business data filter being used to format, convert, or validate the business data; and
binding data processed by the business data filter to the variable in the template file, and generating a variable value usable for rendering.

4. The method according to claim 1, wherein the generating final page codes based on the optimized rendering codes through the template engine and removing redundant information from the final page codes and sending the final page codes to the client device for rendering and displaying comprises:
generating HyperText Markup Language HTML codes for the page to be accessed based on the optimized rendering codes;
performing an optimization processing on the HTML codes by removing a whitespace character and comments from the redundant information;
sending optimized HTML codes as the final page codes to the client device for rendering and displaying.

5. The method according to claim 1, wherein before obtaining final page codes by using the template engine to generate the final page codes based on the optimized rendering codes and remove redundant information from the final page codes, the method further comprises:
performing a security check on the optimized rendering codes and detecting whether the optimized rendering codes have any target security vulnerability;
in response that the optimized rendering codes have a target security vulnerability, processing the optimized rendering codes combined with preset repair prompt text corresponding to the target security vulnerability by a code repair model, and initiating an automatic repair procedure for the optimized rendering codes;
performing a secondary security check on repaired rendering code, and outputting an alarm message in response that the target security vulnerability has been detected again.

6. The method according to claim 1, wherein the obtaining optimized rendering codes by binding business data obtained from the data source to corresponding variable in the template file according to the correspondence relationship between the variable and the business data comprises:
obtaining historical behavior data of a user from a user behavior database according to a user identifier of the page access request;
generating a personalized product recommendation list by invoking a preset personalized recommendation algorithm based on the historical behavior data;
formatting the personalized product recommendation list according to a preset business data filter of the template file;
setting a formatted product recommendation list as the business data and binding the business data to the variable of the template file.

7. The method according to claim 1, further comprising:
after receiving page access requests sent by the client device in a high-concurrency scenario, sorting the page access requests according to a preset priority rule and invoking the template engine for rendering webpage according to a sorting order;
enabling a multi-threading mechanism for parsing a plurality of template files simultaneously when the template engine parses the template file corresponding to each request of the page access requests;
caching static resources of the final page codes when generating the final page codes corresponding to each request;
sending a generated final page codes to the client device corresponding to each request after performing a compression processing the generated final page codes.

8. A server comprising:
a storage device;
at least one processor; and
the storage device storing one or more programs that, when executed by the at least one processor, cause the at least one processor to:
in response to a page access request sent by a client device, obtain a template file according to a page identifier of a page to be accessed of the page access request by invoking a template engine developed based on a compiled language;
generate an abstract syntax tree by parsing the template file through the template engine, the abstract syntax tree representing logical relationship information among a mixed operation expression, a variable scope, a predefined tag, a business data filter, and a control statement of the template file; and
perform a static verification and optimization on the logical relationship information of the template file by the template engine based on the abstract syntax tree, and obtaining optimized rendering codes by binding business data obtained from a data source to corresponding variable in the template file according to the correspondence relationship between the variable and the business data; and
generate final page codes based on the optimized rendering codes through the template engine and remove redundant information from the final page codes and send the final page codes to the client device for rendering and displaying.

9. The server according to claim 8, wherein the at least one processor performs the static verification and the optimization on the logical relationship information of the template file by any one or any combination of the following:
performing a priority parsing and a syntax verification on the mixed operation expression of the template file and determining that the mixed operation expression complies with an operation rule;
based on a scope chain of the variable established during a template file parsing phase and represented in the abstract syntax tree, verifying a definition and an invocation of the variable that complies with a scope rule;
performing a semantic verification on a predefined tag and determining whether the predefined tag complies with a first predefined rule;
verifying an invocation interface of a business data filter and determining whether the invocation interface of the business data filter complies with a second predefined rule, the business data filter being invoked to process the business data for binding to the variable;
verifying the syntax and logical structure of a control statement and determining whether expression of the control statement complies with a preset language rule.

10. The server according to claim 9, wherein the at least one processor obtains optimized rendering codes by binding business data obtained from a data source to corresponding variable in the template file according to the correspondence relationship between the variable and the business data by:
obtaining business data related to the page to be accessed from the data source according to a correspondence relationship between the variable and the business data;
invoking a business data filter is to process the business data, wherein the business data filter being used to format, convert, or validate the business data; and
binding data processed by the business data filter to the variable in the template file and generating a variable value usable for rendering.

11. The server according to claim 8, wherein at least one processor generates final page codes based on the optimized rendering codes through the template engine and removes redundant information from the final page codes and sends the final page codes to the client device for rendering and displaying by:
generating HyperText Markup Language HTML codes for the page to be accessed based on the optimized rendering codes;
performing an optimization processing on the HTML codes by removing a whitespace character and comments from the redundant information;
sending optimized HTML codes as the final page codes to the client device for rendering and displaying.

12. The server according to claim 8, wherein before at least one processor generates final page codes based on the optimized rendering codes through the template engine and removes redundant information from the final page codes and sends the final page codes to the client device for rendering and displaying, at least one processor is further caused to:
perform a security check on the optimized rendering codes and detect whether optimized rendering codes have any target security vulnerability;
in response that the optimized rendering codes have a target security vulnerability, process the optimized rendering codes combined with preset repair prompt text corresponding to the target security vulnerability by a code repair model, and initiate an automatic repair procedure for the optimized rendering codes;
perform a secondary security check on repaired rendering code, and output an alarm message in response that the target security vulnerability has been detected again.

13. The server according to claim 8, wherein at least one processor obtains optimized rendering codes by binding business data obtained from the data source to corresponding variable in the template file according to the correspondence relationship between the variable and the business data by:
obtaining historical behavior data of a user from a user behavior database according to a user identifier of the page access request;
generating a personalized product recommendation list by invoking a preset personalized recommendation algorithm based on the historical behavior data;
formatting the personalized product recommendation list according to a preset business data filter of the template file;
setting a formatted product recommendation list as the business data and binding the business data to the variable of the template file formatted product recommendation list.

14. The server according to claim 8, wherein at least one processor is further caused to:
after receiving page access requests sent by the client device in a high-concurrency scenario, sort the page access requests according to a preset priority rule and invoke the template engine for rendering webpage according to a sorting order;
enable a multi-threading mechanism for parsing a plurality of template files simultaneously when the template engine parses the template file corresponding to each request of the page access requests;
cache static resource of the final page codes when generating the final page codes corresponding to each request;
send a generated final page codes to the client device corresponding to each request after performing a compression processing the generated final page codes.

15. A non-transitory storage medium having instructions stored thereon, when the instructions are executed by a processor of an electronic device, the processor is caused to perform a method for rendering a webpage, wherein the method comprises:
in response to a page access request sent by a client device, obtaining a template file according to a page identifier of a page to be accessed of the page access request by invoking a template engine developed based on a compiled language;
generating an abstract syntax tree by parsing the template file through the template engine, the abstract syntax tree representing logical relationship information among a mixed operation expression, a variable scope, a predefined tag, a business data filter, and a control statement of the template file; and
performing a static verification and an optimization on the logical relationship information of the template file by the template engine based on the abstract syntax tree, and obtaining optimized rendering codes by binding business data obtained from a data source to corresponding variable in the template file according to the correspondence relationship between the variable and the business data; and
generating final page codes based on the optimized rendering codes through the template engine and removing redundant information from the final page codes and sending the final page codes to the client device for rendering and displaying.

16. The non-transitory storage medium according to claim 15, wherein
the performing the static verification and optimization on the logical relationship information of the template file comprises any one or any combination of the following:
performing a priority parsing and a syntax verification on the mixed operation expression of the template file and determining that the mixed operation expression complies with an operation rule;
based on a scope chain of the variable established during a template file parsing phase and represented in the abstract syntax tree, verifying a definition and an invocation of the variable that complies with a scope rule;
performing a semantic verification on a predefined tag and determining whether the predefined tag complies with a first predefined rule;
verifying an invocation interface of a business data filter and determining whether the invocation interface of the business data filter complies with a second predefined rule, the business data filter being invoked to process the business data for binding to the variable;
verifying the syntax and logical structure of a control statement and determining whether expression of the control statement complies with a preset language rule.

17. The non-transitory storage medium according to claim 16, obtaining optimized rendering codes by binding business data obtained from a data source to corresponding variable in the template file according to the correspondence relationship between the variable and the business data comprises:
obtaining business data related to the page to be accessed from the data source according to a correspondence relationship between the variable and the business data;
invoking a business data filter to process the business data, wherein the business data filter being used to format, convert, or validate the business data; and
binding data processed by the business data filter to the variable in the template file, and generating a variable value usable for rendering.

18. The non-transitory storage medium according to claim 15, wherein the generating final page codes based on the optimized rendering codes through the template engine and removing redundant information from the final page codes and sending the final page codes to the client device for rendering and displaying comprises:
generating HyperText Markup Language HTML codes for the page to be accessed based on the optimized rendering codes;
performing an optimization processing on the HTML codes by removing a whitespace character and comments from the redundant information;
sending an optimized HTML codes as the final page codes to the client device for rendering and displaying.

19. The non-transitory storage medium according to claim 15, wherein before generating final page codes based on the optimized rendering codes through the template engine and removing redundant information from the final page codes and sending the final page codes to the client device for rendering and displaying, the method further comprises:
performing a security check on the optimized rendering codes and detecting whether the optimized rendering codes have any target security vulnerability;
in response that the optimized rendering codes have a target security vulnerability, processing the optimized rendering codes combined with preset repair prompt text corresponding to the target security vulnerability by a code repair model, and initiating an automatic repair procedure for the optimized rendering codes;
performing a secondary security check on repaired rendering code, and outputting an alarm message in response that the target security vulnerability has been detected again.

20. The non-transitory storage medium according to claim 15, wherein the obtaining optimized rendering codes by binding business data obtained from the data source to corresponding variable in the template file according to the correspondence relationship between the variable and the business data comprises:
obtaining historical behavior data of a user from a user behavior database according to a user identifier of the page access request;
generating a personalized product recommendation list by invoking a preset personalized recommendation algorithm based on the historical behavior data;
formatting the personalized product recommendation list according to a preset business data filter of the template file;
setting a formatted product recommendation list as the business data and binding the business data to the variable of the template file.
